(19) United States
(12) Patent Application Publication
(10) Pub. No.: US 2022/0186059 A1
(43) Pub. Date: Jun. 16, 2022

(54) INK COMPOSITION INCLUDING A MODIFIED FATTY ALCOHOL POLYGLYCOL ETHER SURFACTANT

(71) Applicant: HEWLETT-PACKARD DEVELOPMENT COMPANY, L.P., Spring, TX (US)

(72) Inventors: Fereshteh KHORRAMI, San Diego, CA (US); Nicholas J. STEWART, San Diego, CA (US); Pranvera KOLARI, San Diego, CA (US)

(73) Assignee: HEWLETT-PACKARD DEVELOPMENT COMPANY, L.P., Spring, TX (US)

(21) Appl. No.: 17/599,335

(22) PCT Filed: Jan. 20, 2020
(86) PCT No.: PCT/US2020/014249

§ 371 Date: Sep. 28, 2021

(51) Int. Cl. C09D 11/328; C09D 11/037; C09D 11/033; C09D 11/102; C09D 11/36; D06P 5/30; D06P 5/20; B41M 5/00

(52) U.S. Cl. CPC C09D 11/328; C09D 11/037; C09D 11/033; B41M 5/0023; C09D 11/36; D06P 5/30; D06P 5/2077; C09D 11/102

(57) ABSTRACT

Examples of the present disclosure are directed toward an ink composition including a surfactant. An example ink composition consistent with the present disclosure includes a dye colorant dispersion, a solvent, a chelating agent, an oleth-3-phosphate, and a surfactant including a modified fatty alcohol polyglycol ether. In various examples, the dye colorant dispersion is present in an amount ranging from about 1.0 wt % to about 7.0 wt % based on a total weight of the ink, and the solvent is present in an amount ranging from about 10 wt % to about 22 wt % based on the total weight of the ink. The chelating agent may be present in an amount ranging from about 0.05 wt % to about 0.2 wt % based on the total weight of the ink, and the oleth-3-phosphate is in an amount ranging from about 0.1 wt % to about 0.3 wt % based on the total weight of the ink.

### BACKGROUND

Textile printing methods include rotary and/or flat-screen printing. Analog printing involves the creation of a plate or a screen, i.e., an actual physical image from which ink is transferred to the textile. Both rotary and flat screen printing have great volume throughput capacity. For large images, pattern repeats are used. Digital inkjet printing enables greater flexibility in the printing process, where images of any desirable size can be printed immediately from an electronic image without pattern repeats. Inkjet printers, and piezoelectric inkjet printers, are gaining rapid acceptance for digital textile printing. Inkjet printing is a non-impact printing method that utilizes electronic signals to control and direct droplets or a stream of ink to be deposited on media.

### BRIEF DESCRIPTION OF THE DRAWINGS

FIG. 1, illustrates an example method, consistent with the present disclosure.

FIG. 2 illustrates experimental cyan inks including a surfactant at 1.2 weight %, consistent with the present disclosure.

FIG. 3 illustrates experimental cyan inks including a surfactant at 3.0 weight %, consistent with the present disclosure.

FIG. 4 illustrates coated textile cross sections showing ink penetration, consistent with the present disclosure.

### DETAILED DESCRIPTION

In the following detailed description, reference is made to the accompanying drawings which form a part hereof, and in which is shown by way of illustration specific examples in which the disclosure may be practiced. It is to be understood that other examples may be utilized, and structural or logical changes may be made without departing from the scope of the present disclosure. The following detailed description, therefore, is not to be taken in a limiting sense, and the scope of the present disclosure is defined by the appended claims. It is to be understood that features of the various examples described herein may be combined, in part or whole, with each other, unless specifically noted otherwise. Throughout this disclosure, a weight percentage that is referred to as “wt %” refers to the loading of a component of a dispersion or other formulation that is present in the ink formulation.

Various types of printers may be used to print on fabrics. For instance, a dye-sublimation printer, which uses heat to transfer dye onto materials such as a plastic, card, paper, or fabric may be used. During dye-sublimation, the dye transitions between the solid and gas states without going through a liquid stage. While printing directly on textiles, ink wetting properties are controlled to prevent the ink from bleeding. As a result, the textiles are coated to reduce the dye migration. When controlling the ink migration, it may be desirable to have all colorants, such as cyan, magenta, yellow, and black, to have equal spread, dot gain, and penetration on the textile. However, inks that are designed for dye-sublimation technology often do not have equal spread, dot gain, and penetration across colorants, with cyan having the smallest dot-gain compared to magenta, yellow and black.

Additionally, sublimation dyes are often dispersed along with unknown binders and/or polymers at the supplier to stabilize the dye. These inks are jetted to a transfer medium and then calendared at high pressure and temperature for the dye to vaporize and sublimate onto the textile substrate. However, over time, the print head resistor degrades as a result of residual ink and/or water impurities. This resistor degradation is referred to as kogation. Kogation resistor life testing may be conducted to measure the number of drops of ink that may be jetted through a single nozzle. A longer resister life results in more reliable inkjet cartridges, reduces environmental waste, and improves warranty programs.

Examples of the present disclosure are directed toward an ink composition to equalize the interaction of all colorants with the coated textile, and particularly improves the dot-gain of cyan. Additionally, examples of the present disclosure are directed toward an ink composition to improve the longevity of sublimation inkjet resistors. An example ink composition consistent with the present disclosure includes a dye colorant dispersion, a solvent, a chelating agent, an oleth-3-phosphate, and a surfactant. In various examples, the dye colorant dispersion is present in an amount ranging from about 1.0 wt % to about 7.0 wt % based on a total weight of the ink. The solvent may be selected from the group consisting of glycerol, ethoxylated glycerol, 2-methyl-1,3-propanediol, dipropylene glycol, and combinations thereof, the solvent being present in an amount ranging from about 10 wt % to about 22 wt % based on the total weight of the ink. The chelating agent may be present in an amount ranging from about 0.05 wt % to about 0.2 wt % based on the total weight of the ink. The oleth-3-phosphate may be present in an amount ranging from about 0.1 wt % to about 0.3 wt % based on the total weight of the ink, and the surfactant may include a modified fatty alcohol polyglycol ether. The ink formulation with surfactant described herein significantly improves drop velocity of ink from a printhead resistor after repeated use. Similarly, the ink formulation has been shown to improve dot-gain of cyan, such that each of the colors in an ink formulation migrates in a similar manner.

In another particular example, the ink composition includes a dye colorant dispersion present in an amount ranging from about 1.0 wt % to about 7.0 wt % based on a total weight of the ink, and a solvent selected from the group consisting of glycerol, ethoxylated glycerol, 2-methyl-1,3-propanediol, dipropylene glycol, and combinations thereof, the solvent being present in an amount ranging from about 10 wt % to about 22 wt % based on the total weight of the ink. The ink composition may further include a chelating agent selected from the group consisting of methylglycinediacetic acid, trisodium salt, 4,5-dihydroxy-1,3-benzenedisulfonic acid disodium salt monohydrate, ethylenediaminetetraacetic acid (EDTA), hexamethylenediamine tetra(methylene phosphonic acid), potassium salt, and combinations thereof, the chelating agent present in an amount ranging from about 0.05 wt % to about 0.25 wt % based on the total weight of the ink. Yet further, the ink composition may include oleth-3-phosphate present in an amount ranging from about 0.1 wt % to about 0.75 wt % based on the total weight of the ink, a surfactant including a modified fatty alcohol polyglycol ether in an amount ranging from about 1.2 wt % to about 3.0 wt % based on the total weight of the ink, and a biocide in an amount ranging from about 0.08 wt % to about 0.5 wt % based on the total weight of the ink.

In yet a further example, the present disclosure relates to a method comprising thermal inkjet printing, from a thermal inkjet printhead, an ink composition onto a coated textile substrate. In such examples, the ink composition includes a dye colorant dispersion present in an amount ranging from about 1.0 wt % to about 7.0 wt % based on a total weight of the ink, a solvent selected from the group consisting of glycerol, Liponic® EG-1 (LEG-1), and combinations thereof, the solvent being present in an amount ranging from about 10 wt % to about 22 wt % based on the total weight of the ink. The ink composition further includes a chelating agent present in an amount ranging from about 0.05 wt % to about 0.2 wt % based on the total weight of the ink, oleth-3-phosphate present in an amount ranging from about 0.1 wt % to about 0.3 wt % based on the total weight of the ink, and a surfactant including a modified fatty alcohol polyglycol ether, the surfactant in an amount ranging from about 0.1 wt % to about 0.4 wt %. The method further includes exposing the ink on the textile substrate to a post-treatment process involving at least heat to form an image on the textile substrate.

In accordance with the present disclosure, the ink formulation disclosed herein includes a plurality of components. In various examples, the ink formulation consists of a dye colorant dispersion present in an amount ranging from about 1.0 wt % to about 7.0 wt % based on a total weight of the ink. In the examples disclosed herein, the dye colorant dispersion may be any color. In an example, the dye colorant dispersion is selected from the group consisting of a black dye colorant dispersion, a magenta dye colorant dispersion, and a yellow dye colorant dispersion. Each dye colorant dispersion includes a disperse dye, a polymeric dispersant, and a dispersion vehicle. The disperse dye included in the colorant dispersion may depend on the desired color for the ink formulation.

Black dye colorant dispersions often include a blend of disperse dyes, such as, for example, blends of blue, brown and yellow disperse dyes, or blends of blue, orange and violet disperse dyes, or blends of blue, orange and yellow disperse dyes, or blue, magenta, and yellow dyes. An example of a blue, brown and yellow disperse dye blend include disperse blue 360 (DB360), disperse brown 27, and disperse yellow 54 (DY54). Some examples of blue, orange and violet disperse dye blends include disperse blue 291:1 (DB291:1), disperse orange 29 (DO29) and disperse violet 63, or DB291:1, DO29 and disperse violet 99. An example of a blue, orange and yellow dye blend includes DB360, disperse orange 25, and DY54. An example of a blue, magenta, and yellow dye blend includes disperse blue 77 (DB77), disperse red 92, and disperse yellow 1 14 (DY114).

Magenta dye colorant dispersions may include red disperse dyes, such as disperse red 60, disperse red 82, disperse red 86, disperse red 86:1, disperse red 167:1, disperse red 279, and mixtures thereof.

Yellow dye colorant dispersions may include yellow disperse dyes, such as DY54, disperse yellow 64, disperse yellow 71, disperse yellow 86, DY1 14, disperse yellow 153, disperse yellow 233, disperse yellow 245, and mixtures thereof.

The dye colorant dispersion may include from about 10 wt % dye solids to about 20 wt % dye solids based on the total weight of the colorant dispersion. In some examples, the dye colorant dispersion is present in an amount ranging from about 1.0 wt % to about 7.0 wt % based on a total weight of the ink. The dye colorant dispersion may be incorporated into the ink vehicle such that from about 1 wt % to about 7 wt % are present, based on a total weight of the ink formulation. In another example, the dye colorant dispersion may be present in an amount ranging from about 3 wt % to about 5 wt % based on the total weight of the ink formulation. The wt % of the dye colorant dispersion accounts for the loading (as a weight percent) of the dye solids present in the ink and does not account for the weight of the other components (e.g., co-solvent, water, etc.) of the dye colorant dispersion in the ink.

Some examples of the polymeric dispersant (which may also be anionic or non-ionic) include polymers or copolymers of acrylics, methacrylics, acrylates, methacrylates, styrene, substituted styrene, a-methylstyrene, substituted a-methyl styrenes, vinyl naphthalenes, vinyl pyrollidones, maleic anhydride, vinyl ethers, vinyl alcohols, vinyl alkyls, vinyl esters, vinyl ester/ethylene copolymers, acrylamides, and/or methacrylamides. Some examples include a styrene methacrylic acid copolymer, a styrene acrylic acid copolymer, styrene acrylic acid-acrylic ester copolymers, styrene methacrylic acid-acrylic ester copolymers, a styrene maleic anhydride copolymer, polyacrylic acid partial alkyl ester, polyalkylene polyamine, polyacrylates, and vinyl naphthalene-maleic acid copolymers. Another example of a polymeric dispersant is a polyurethane polymer. Still other examples of polymeric dispersants for the dye colorant dispersion include block acrylic copolymers, including A-B block copolymers such as benzyl methacrylate-methacrylic acid diblock copolymers and butyl methacrylate-methacrylic acid diblock copolymers. Still further examples of polymeric dispersants include ABC triblock copolymers, such as benzyl methacrylate-methacrylic acid-ethoxytriethyleneglycol methacrylate triblock copolymers and butyl methacrylate-methacrylic acid-ethoxytriethyleneglycol methacrylate triblock copolymers. Still some other examples of dispersants include different acid value acrylic resins, such as JONCRYL® 586, 671 , 675, 678, 680, 683, 690, 693, and 695 (from BASF Corp.).

The dispersion vehicle may include water and a water soluble or water miscible co-solvent. Examples of the water soluble or water miscible co-solvent in the dye colorant dispersion may include alcohols (e.g., diols, such as 1,2-propanediol, 1,3-propanediol, etc.), ketones, ketoalcohols, ethers (e.g., the cyclic ether tetrahydrofuran (THF), and others, such as thiodiglycol, sulfolane, 2-pyrrolidone, 1-(2-hydroxyethyl-2-pyrrolidone, 1,3-dimethyl-2-imidazolidinone and caprolactam); glycols such as ethylene glycol, diethylene glycol, tritriethylene glycol, tetraethylene glycol, propylene glycol, dipropylene glycol, tripropylene glycol, trimethylene glycol, butylene glycol, and hexylene glycol; addition polymers of oxyethylene or oxypropylene such as polyethylene glycol, polypropylene glycol and the like; triols such as glycerol and 1,2,6-hexanetriol; lower alkyl ethers of polyhydric alcohols, such as ethylene glycol monomethyl ether, ethylene glycol monoethyl ether, diethylene glycol monomethyl, and diethylene glycol monoethyl ether; and lower dialkyl ethers of polyhydric alcohols, such as diethylene glycol dimethyl or diethyl ether.

One or more of these co-solvents may be present in the dye colorant dispersion in respective amounts ranging from about 1 wt % to about 5 wt %, based on the total weight of the colorant dispersion. The balance of the dye colorant dispersion is water, such as purified water or deionized water.

To form the ink composition disclosed herein, the dye colorant dispersion is incorporated into an ink vehicle, which includes the primary solvent, the secondary solvent, the oleth-3-phosphate or the specific combination of the chelating agent and the oleth-3-phosphate, additive(s), and water.

The primary solvent may help to maintain the nozzle health of the thermal inkjet printheads, and to provide substantially consistent print quality over the life of the printhead. In an example, the primary solvent is selected from the group consisting of glycerol, ethoxylated glycerol, 2-methyl-1,3-propanediol, dipropylene glycol, and combinations thereof. The primary solvent is present in an amount ranging from about 10 wt % to about 22 wt % based on the total weight of the ink. It is to be understood that whether a single primary solvent is used, or a combination of the primary solvents is used, the total amount of primary solvents is within the given range. In one example, the primary solvent includes a combination of glycerol and ethoxylated glycerol. In this example, the glycerol is present in an amount ranging from about 12 wt % to about 16 wt % based on the total weight of the ink, and the ethoxylated glycerol is present in an amount ranging from greater than 0 wt % to about 5 wt % based on the total weight of the ink.

The ink formulation may also include the secondary solvent present in an amount ranging from 0 wt % to about 7 wt % based on the total weight of the ink. The secondary solvent may be added to the ink vehicle or may be included as part of the dye colorant dispersion. The co-solvent(s) is present in the dye colorant dispersion in relatively low amounts (1 wt % to about 5 wt % based on the total weight of the colorant dispersion), and thus a fraction of the co-solvent(s) is carried over to the ink disclosed herein depending, in part, upon the dispersion solids and the loading of the dispersion in the ink.

In various examples, the chelating agent is present in an amount ranging from about 0.05 wt % to about 0.2 wt % based on the total weight of the ink. In additional examples, the chelating agent is present in an amount ranging from about 0.05 wt % to about 0.25 wt % based on the total weight of the ink. In an additional example, the chelating agent is present in an amount ranging from about 0.05 wt % to about 0.15 wt % based on the total weight of the ink. The wt % of the chelating agent accounts for the loading (as a weight percent) of the chelator/chelating agent present in the ink and does not account for the weight of other components of the chelating agent solution (e.g., water) in the inkjet ink. For yellow inks, the chelating agent may be present in an amount ranging from 0 wt % to less than 0.1 wt % based on the total weight of the ink. For black and magenta inks, the chelating agent may be present in an amount greater than 0 wt % to less than 0.1 wt % based on the total weight of the ink.

In an example, the chelating agent is selected from the group consisting of methylglycinediacetic acid, trisodium salt; 4,5-dihydroxy-1,3-benzenedisulfonic acid disodium salt monohydrate; ethylenediaminetetraacetic acid (EDTA); hexamethylenediamine tetra(methylene phosphonic acid), potassium salt; and combinations thereof. Methylglycinediacetic acid, trisodium salt (Na₃MGDA) is commercially available as TRILON® M from BASF Corp. 4,5-dihydroxy-1,3-benzenedisulfonic acid disodium salt monohydrate is commercially available as TIRON™ monohydrate. Hexamethylenediamine tetra(methylene phosphonic acid), potassium salt is commercially available as DEQUEST® 2054 from Italmatch Chemicals.

In various examples, the oleth-3-phosphate is present in an amount ranging from about 0.1 wt % to about 0.3 wt % based on the total weight of the ink. Additionally, and/or alternatively, the oleth-3-phosphate may be present in an amount ranging from about 0.2 wt % to about 0.5 wt %. Similarly, in various examples the oleth-3-phosphate may be present in an amount ranging from about 0.1 wt % to about 0.75 wt % based on the total weight of the ink. Oleth-3-phosphate is commercially available as CRODAFOS™ 03A or CRODAFOS™ N-3 acid from Croda.

In various examples, the ink formulation includes a surfactant comprising an aqueous solution of a modified fatty alcohol polyglycol ether. The general structure of the surfactant is as follows:

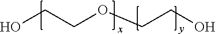

The surfactant includes a high amount of ethylene oxide as compared to other nonionic surfactants. For instance, in various examples the surfactant includes greater than 10 groups of ethylene oxide per molecule. In additional examples, the surfactant includes around 35 to 45 groups of ethylene oxide per molecule. Moreover, in various examples the surfactant has a hydrophilic lipophilic balance (HLB) ranging from about 15 to about 20. As an illustration, the surfactant may be a nonionic surfactant with a hydrophilic lipophilic balance (HLB) ranging from about 17 to about 19. In various examples, the HLB may be about 18. Such polyethoxy surfactants may be characterized using liquid chromatography mass spectrometry (LCMS). An example of such surfactant is commercially available as DISPONIL® AFX 4030 US from BASF Corp.

In an example, the surfactant is present in an amount ranging from about 0.1 wt % to about 0.4 wt %. In an additional example, the surfactant is present in an amount ranging from about 1.1 wt % to about 3.1 wt %. Similarly, the surfactant may be present in an amount ranging from about 1.2 wt % to about 3.0 wt % based on the total weight of the ink. In various additional examples, the surfactant is present in an amount ranging from about 1.8 wt % to about 2.2 wt % based on the total weight of the ink.

The ink formulation disclosed herein also includes an additive selected from the group consisting of a buffer, a biocide, another surfactant (in addition to the oleth-3-phosphate), and combinations thereof.

In an example, the pH of the ink formulation ranges from about 7 to about 9.5 at the time of manufacture. In another example, the pH of the ink formulation ranges from about 8 to about 9 at the time of manufacture. pH adjuster(s), such as a buffer, may be added to the ink to counteract any slight pH drop that may occur over time. The pH may drop from about 0.5 units to about 1 unit over time after being manufactured. As such, the pH of the inks disclosed herein may be lower than the ranges set forth herein, depending, in part, upon how much time has passed since manufacture. In an example, the total amount of buffer(s) in the ink ranges from 0 wt % to about 0.5 wt % (with respect to the weight of the ink formulation). In another example, the total amount of buffer(s) in the ink is about 0.1 wt % (with respect to the weight of the ink formulation). Examples of some suitable buffers include TRIS (tris(hydroxymethyl)aminomethane or Trizma), bis-tris propane, TES (2-[(2-Hydroxy-1,1-bis(hydroxymethyl)ethyl)amino]ethanesulfonic acid), MES (2-ethanesulfonic acid), MOPS (3-(N-morpholino)propanesulfonic acid), HEPES (4-(2-hydroxyethyl)-1-piperazineethanesulfonic acid), DIPSO (3-(N,N-Bis[2-hydroxyethyl]amino)-2-hydroxypropanesulfonic acid), Tricine (N-[tris(hydroxymethyl)methyl]glycine), HEPPSO (P-Hydroxy-4-(2-hydroxyethyl)-1-piperazinepropanesulfonic acid monohydrate), POPSO (Piperazine-1,4-bis(2-hydroxypropanesulfonic acid) dihydrate), EPPS (4-(2-Hydroxyethyl)-1-piperazinepropanesulfonic acid, 4-(2-Hydroxyethyl)piperazine-1-propanesulfonic acid), TEA (triethanolamine buffer solution), Gly-Gly (Diglycine), bicine (N,N-Bis(2-hydroxyethyl)glycine), HEPBS (N-(2-Hydroxyethyl)piperazine-N′-(4-butanesulfonic acid)), TAPS ([tris(hydroxymethyl)methylamino]propanesulfonic acid), AMPD (2-amino-2-methyl-1,3-propanediol), TABS (N-tris(Hydroxymethyl)methyl-4-aminobutanesulfonic acid), or the like.

In an example, the total amount of biocide(s) in the ink formulation ranges from about 0 wt % to about 0.5 wt %. For instance, the ink formulation may include a biocide in an amount ranging from about 0.08 wt % to about 0.5 wt % based on the total weight of the ink. In another example, the total amount of biocide(s) in the ink formulation is about 0.001 wt % to about 0.1 wt %. The wt % of the biocide accounts for the loading (as a weight percent) of the biocidal agent present in the ink and does not account for the weight of other components of the biocide (e.g., water) in the inkjet ink.

Examples of biocides include the NUOSEPT® (Ashland Inc.), UCARCIDE™ or KORDEK™ or ROCIMA™ (Dow Chemical Co.), PROXEL® (Arch Chemicals) series, ACTICIDE® B20 and ACTICIDE® M20 and ACTICIDE® MBL (blends of 2-methyl-4-isothiazolin-3-one (MIT), 1,2-benzisothiazolin-3-one (BIT), and Bronopol) (Thor Chemicals), AXIDE™ (Planet Chemical), NIPACIDE™ (Clariant), blends of 5-chloro-2-methyl-4-isothiazolin-3-one (CIT or CMIT) and MIT under the tradename KATHON™ (Dow Chemical Co.) and combinations thereof.

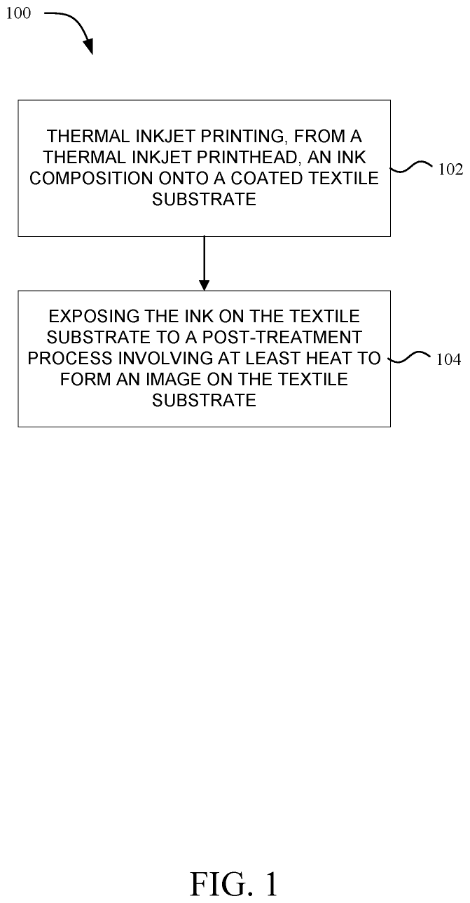

Referring now to the figures, FIG. 1, illustrates an example method 100, consistent with the present disclosure. Examples of the ink formulation disclosed herein may be dispensed from a thermal inkjet printhead during examples of the printing method 100. One example of the method 100 is shown at reference numerals 102 and 104.

As illustrated in FIG. 1, the method 100 shown at reference numerals 102 includes thermal inkjet printing, from a thermal inkjet printhead, an ink composition onto a coated textile substrate. As described herein, the ink composition includes a dye colorant dispersion present in an amount ranging from about 1.0 wt % to about 7.0 wt % based on a total weight of the ink. Additionally, the ink composition includes a solvent selected from the group consisting of glycerol, Liponic® EG-1 (LEG-1), and combinations thereof, the solvent being present in an amount ranging from about 10 wt % to about 22 wt % based on the total weight of the ink. The ink composition may further include a chelating agent present in an amount ranging from about 0.05 wt % to about 0.2 wt % based on the total weight of the ink. Moreover, oleth-3-phosphate present in an amount ranging from about 0.1 wt % to about 0.3 wt % based on the total weight of the ink. The ink formulation includes a surfactant including a modified fatty alcohol polyglycol ether, the surfactant in an amount ranging from about 0.1 wt % to about 0.4 wt %.

In various examples, the method includes thermal inkjet printing, from the thermal inkjet printhead, the dye sublimation ink directly onto a textile substrate. Any examples of the ink disclosed herein may be used in this example of the method 100.

The textile substrate may be polyester fabric, a polyester coated surface, blends of polyester and other materials (e.g., cotton, linen, etc.). In one example, the polyester blend includes from about 70 wt % to about 80 wt % of the polyester. Examples of materials that may be coated with polyester include glass, metal, wood, plastics, ceramics, etc.

As shown at reference numeral 104, the method includes exposing the ink on the textile substrate to a post-treatment process involving at least heat to form an image on the textile substrate. Once the ink formulation is thermal inkjet printed directly on the textile, the textile may be exposed to heat, or heat and pressure. The heat, or heat and pressure is enough to sublimate the disperse dye so that it converts to a gas and penetrates the textile. The heat, or heat and pressure may also be enough to open the fibers of the textile substrate and allow the dye to migrate into the fibers. The dye then re-solidifies on the fibers of the textile substrate, which renders the printed image durable, wash-resistant, and colorfast. The heat to initiate sublimation may range from about 182° C. to about 215° C., and the pressure may range from 0 psi to about 100 psi. The image on the transfer medium is then transferred to the desired textile substrate. To make the transfer, the printed-on transfer medium is placed into contact with the textile substrate, and the two are exposed to heat, or heat and pressure to affect the sublimation. The transfer process may involve a heat press or a calender. In the heat press or calender, the printed transfer medium is brought into contact with the textile substrate that is to be imaged. The heat to initiate sublimation may range from about 182° C. to about 215° C., and the pressure may range from 0 psi to about 100 psi. The sublimated dye is converted to a gas and can penetrate the textile substrate it is in contact with. The dye then resolidifies on the fibers of the textile substrate, which renders the printed image durable, wash-resistant, and colorfast. The heat to initiate sublimation may range from about 182° C. to about 215° C., and the pressure may range from 0 psi to about 100 psi.

### EXAMPLES

The following illustrates examples of the compositions and related aspects described in the present disclosure. Thus, these examples should not be considered to restrict the present disclosure, but are merely in place to teach how to make examples of compositions of the present disclosure.

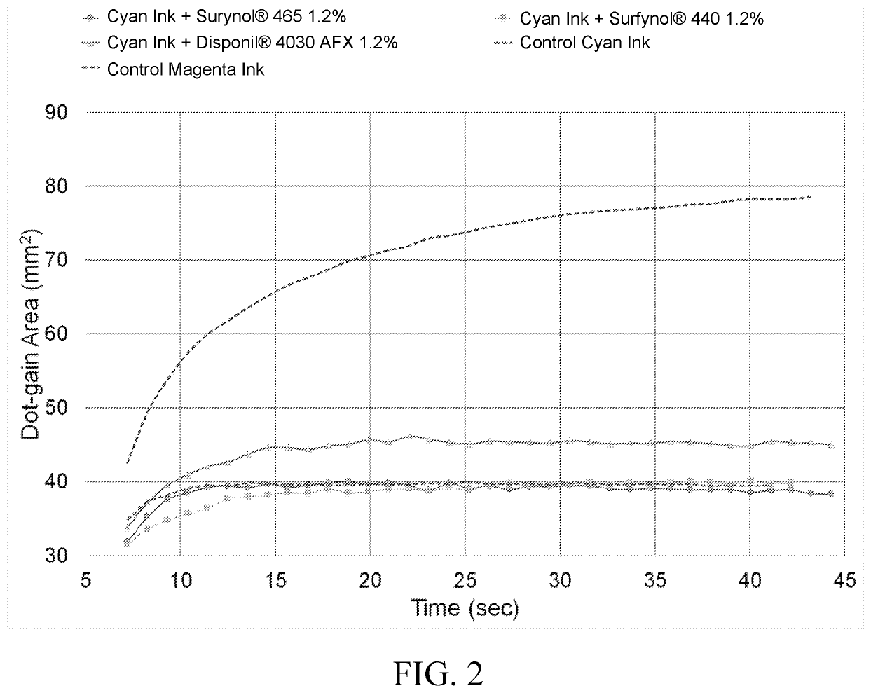

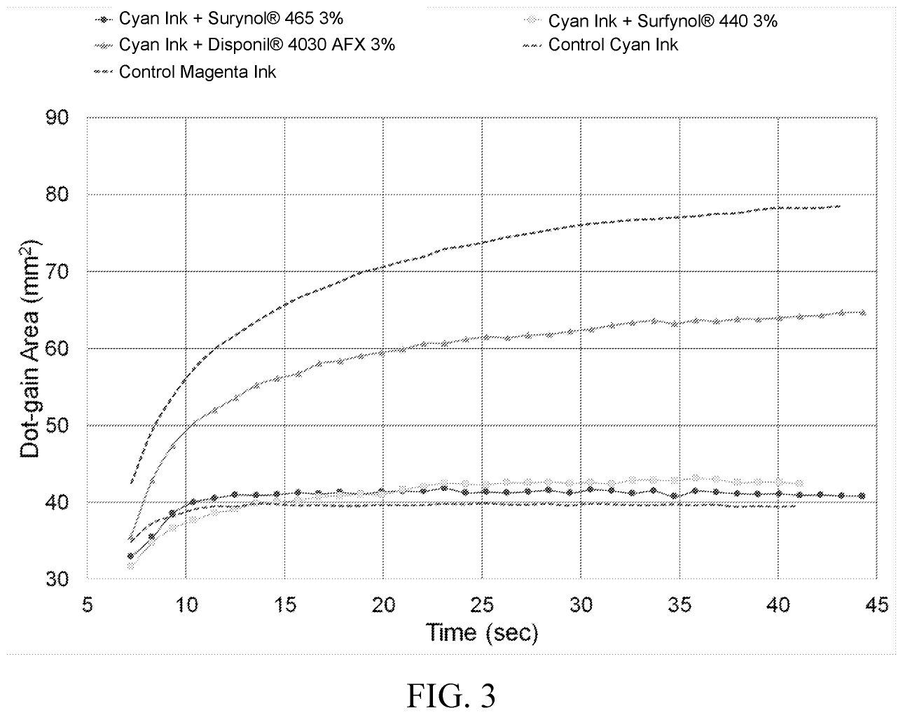

Dot-gain/cold diffusion of inks on coated textile was studied via a pipetting technique. The ink volume (5 μL) and media type (Aberdeen 6243-60 C38) were kept constant throughout the experiment. Multiple cyan ink lots were spiked with 1.2 wt % and 3 wt % of DISPONIL® AFX 4030 and stirred for 2 hours. Also, the same ink was spiked with the surfactants SURFYNOL® 440 and SURFYNOL® 465 (commercially available from Evonik Industries) at the same concentrations. The spread of experimental cyan inks was video recorded via a microscope commercially available from Keyence Corporation, and the video was processed through MATLAB© software from MathWorks Inc., by generating a surface area versus time plot. Experimental cyan inks were compared to control cyan and magenta, as illustrated in FIG. 2 and FIG. 3.

FIG. 2 illustrates experimental cyan inks including a surfactant at 1.2 wt %, consistent with the present disclosure. FIG. 3 also illustrates experimental cyan inks including a surfactant at 3.0 wt %, consistent with the present disclosure. Dot-gain of cyan was improved with incorporation of DISPONIL® AFX 4030 at both concentrations (1.2 wt % and 3 wt %). The dot-gain of these experimental inks is more like that of magenta. FIG. 2 illustrates surface area versus time plot for multiple cyan ink lots spiked with 1.2 wt % SURFYNOL® or 1.2 wt % DISPONIL®. Similarly, FIG. 3 illustrates surface area versus time plot for multiple cyan ink lots spiked with 3.0 wt % SURFYNOL® or 3.0 wt % DISPONIL®. Both FIG. 2 and FIG. 3 illustrate an improved dot-gain of cyan with DISPONIL®, as compared to the cyan control. A comparison of surfactant-enhanced dot-gain of cyan on coated media is illustrated in Table 1, below. The ink lots displayed below include a Cyan ink lot spiked with 3% of SURFYNOL® 440 (Cyan Ink+3% S440); the Cyan ink lot spiked with 3% of SURFYNOL® 465 (Cyan Ink+3% S465); and the Cyan ink lot spiked with 3% of DISPONIL® 4030 (Cyan Ink+3% DISPONIL® 4030 AFX).

TABLE 1

| | | | Cyan Ink + 3% |
|---|---|---|---|
| | Cyan Ink + 3% | Cyan Ink + 3% | DISPONIL ® 4030 |
| | SURFYNOL ® 440 | SURFYNOL ® 465 | AFX |
| Dot Gain | 36 | 40 | 50 |
| Area @ | | | |
| 10 sec | | | |
| (mm2) | | | |
| % Increase | −8.3% | 3% | 28% |
| from Cyan | | | |
| Ink @ | | | |
| 10 sec | | | |
| Dot Gain | 42 | 41 | 63 |
| Area @ | | | |
| 40 sec | | | |
| (mm2) | | | |
| % Increase | 0% | 3% | 60% |
| from Cyan | | | |
| Ink @ | | | |
| 40 sec | | | |

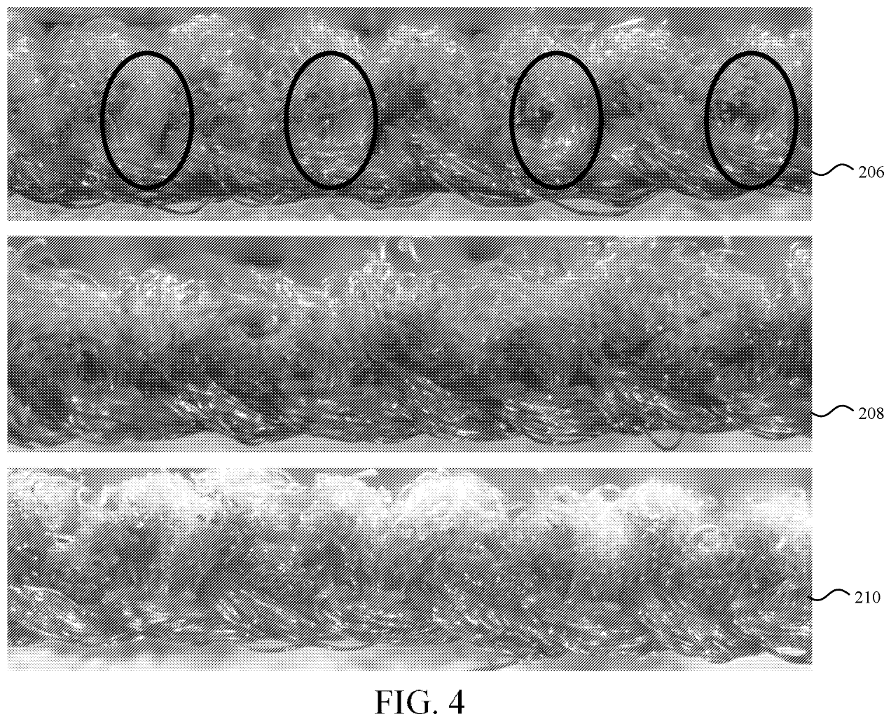

FIG. 4 illustrates ink penetration on coated textile, consistent with the present disclosure. Coated textile (Aberdeen 6243-60 C38) was studied via imaging of the textile cross-section upon printing. Ink formulations were prepared as discussed herein, and the surfactant DISPONIL® AFX 4030 was incorporated during the making of the formulation at concentrations of 1.5 wt % and 3 wt %. Printing was performed on a stitch printer at a drop density of 2 dpp. The textiles were cross-sectioned and imaged on a Keyence microscope. As illustrated in FIG. 4, cyan penetration on coated textile media was enhanced by incorporating DISPONIL®AFX 4030 and ink depth was similar to magenta. Referring to FIG. 4, box 206 illustrates cyan penetration of Aberdeen 6243-60 C38, dispensed at a rate of 2 drops per second, cross-sectioned and magnified 100×. The circles identify areas with the worst cyan penetration. Box 208 illustrates cyan and DISPONIL® AFX 4030 penetration of Aberdeen 6243-60 C38, dispensed at a rate of 2 drops per second, cross-sectioned and magnified 100×. Box 210 illustrates magenta penetration of Aberdeen 6243-60 C38, dispensed at a rate of 2 drops per second, cross-sectioned and magnified 100×. The image at box 208 illustrates improved cyan penetration with the incorporation of DISPONIL® and illustrates an ink depth similar to magenta.

Also, resistor life was tested with the ink formulations described herein. During this experiment, two different disperse blue dye sublimations from two manufacturers were dispersed and then were made into inks. Two of BASF styrene-acrylic pigment dispersion resins were used to stabilize the charges on the pigment in the ink for the resistor life testing. The two chosen polymers included JONCRYL® 671 and JONCRYL® 683.

Next, four different inks were formulated per Table 2 (below). One ink set (e.g., ink formulation #1 and ink formulation #2) used the surfactant SURFYNOL®465 and the second ink set (e.g., ink formulation #3 and ink formulation #4) used the surfactant DISPONIL®AFX 4030.

TABLE 2

| Ink | #1 | #2 | #3 | #4 |
|---|---|---|---|---|
| % Cyan Dye | 4.5% | 4.5% | 4.5% | 4.5% |
| Joncryle ® 671 | 1.0% | | 1.0% | |
| Joncryle ® 683 | | 1.0% | | 1.0% |
| Glycerol | 12.0% | 12.0% | 12.0% | 12.0% |
| Surfyn ® 465 | 0.20% | 0.20% | | |
| Disponi1 ® AFX | | | 0.20% | 0.20% |
| 4030 | | | | |
| Crodafos ™ O3A | 0.20% | 0.20% | 0.20% | 0.20% |
| Trilone ® M | 0.100% | 0.100% | 0.100% | 0.100% |
| TRIS | 0.100% | 0.100% | 0.100% | 0.100% |
| Acticide ® B20 | 0.100% | 0.100% | 0.100% | 0.100% |

Pens were tested for resistor life using each of the inks in Table 2, up to 100 Million Drops Per Nozzles (100 MDPN). Selected nozzles were fired at specific firing parameters up to 100 million drops of ink per each mask nozzle. Last, the pen performance such as drop velocity in m/s was measured for the fired nozzles.

As discussed herein, two different disperse blue dye sublimations from two manufacturers were dispersed and then were made into inks (e.g., ink formulations #1, #2, #3, and #4 discussed in Table 2). As seen in Table 3 (below), the velocity performance of the DISPONIL®AFX 4030 ink formulations (e.g., ink formulations #3 and #4) was superior to the SURFYNOL®465 ink formulations (e.g., ink formulations #1 and #2), regardless of manufacturer. Notations of “failed” indicate that no nozzle drop velocity was reported after 100 million drops were dispensed.

TABLE 3

| | | | | Velocity | |
|---|---|---|---|---|---|
| | | | | Delta | Change DV% |
| | | Initial | | (Final - | (Final- |
| Dispersion ID | Ink | Velocity | Final Velocity | Initial) | Initial)/lnitial |
| Cyan dye | # 1 | 12.7 | 7.9 | −4.8 | −61% |
| from | # 2 | 12.4 | 7.6 | −4.8 | −62% |
| Manufacture # 1 | # 3 | 12.7 | 10.2 | −2.4 | −24% |
| | # 4 | 12.8 | 10.2 | −2.6 | −25% |
| Cyan dye from | # 1 | 11.9 | Failed | Failed | Failed |
| Manufacture # 2 | # 2 | 10.6 | Failed | Failed | Failed |
| | # 3 | 13.0 | 7.5 | −5.5 | −74% |
| | # 4 | 13.6 | 7.6 | −6.0 | −79% |

Although specific examples have been illustrated and described herein, a variety of alternate and/or equivalent implementations may be substituted for the specific examples shown and described without departing from the scope of the present disclosure. This application is intended to cover any adaptations or variations of the specific examples discussed herein. Therefore, it is intended that this disclosure be limited only by the claims and the equivalents thereof.

1. An ink composition, comprising:
a dye colorant dispersion present in an amount ranging from about 1.0 wt % to about 7.0 wt % based on a total weight of the ink;
a solvent selected from the group consisting of glycerol, ethoxylated glycerol, 2-methyl-1,3-propanediol, dipropylene glycol, and combinations thereof, the solvent being present in an amount ranging from about 10 wt % to about 22 wt % based on the total weight of the ink;
a chelating agent present in an amount ranging from about 0.05 wt % to about 0.25 wt % based on the total weight of the ink;
oleth-3-phosphate present in an amount ranging from about 0.1 wt % to about 0.3 wt % based on the total weight of the ink; and
a surfactant including a modified fatty alcohol polyglycol ether.

2. The ink composition of claim 1, wherein the surfactant includes ethylene oxide in an amount ranging from about 35 groups per molecule to about 45 groups per molecule.

3. The ink composition of claim 1, wherein the surfactant is present in an amount ranging from about 0.1 wt % to about 0.4 wt %.

4. The ink composition of claim 1, wherein the surfactant includes greater than 10 groups of ethylene oxide per molecule.

5. The ink composition of claim 1, wherein the surfactant has a hydrophilic lipophilic balance (HLB) ranging from about 15 to about 20.

6. The ink composition of claim 1, wherein the surfactant is present in an amount ranging from about 1.8 wt % to about 2.2 wt % based on the total weight of the ink.

7. The ink composition of claim 1, wherein the surfactant is a nonionic surfactant.

8. The ink composition of claim 1, wherein the oleth-3-phosphate is present in an amount ranging from about 0.2 wt % to about 0.5 wt %.

9. The ink composition of claim 1, wherein the chelating agent is present in an amount ranging from about 0.05 wt % to about 0.15 wt % based on the total weight of the ink.

10. The ink composition of claim 1, the chelating agent selected from the group consisting of methylglycinediacetic acid, trisodium salt, 4,5-dihydroxy-1,3-benzenedisulfonic acid disodium salt monohydrate, ethylenediaminetetraacetic acid (EDTA), hexamethylenediamine tetra(methylene phosphonic acid), potassium salt, and combinations thereof.

11. An ink composition, comprising:
a dye colorant dispersion present in an amount ranging from about 1.0 wt % to about 7.0 wt % based on a total weight of the ink;
a solvent selected from the group consisting of glycerol, ethoxylated glycerol, 2-methyl-1,3-propanediol, dipropylene glycol, and combinations thereof, the solvent being present in an amount ranging from about 10 wt % to about 22 wt % based on the total weight of the ink;
a chelating agent selected from the group consisting of methylglycinediacetic acid, trisodium salt, 4,5-dihydroxy-1,3-benzenedisulfonic acid disodium salt monohydrate, ethylenediaminetetraacetic acid (EDTA), hexamethylenediamine tetra(methylene phosphonic acid), potassium salt, and combinations thereof, the chelating agent present in an amount ranging from about 0.05 wt % to about 0.25 wt % based on the total weight of the ink;
oleth-3-phosphate present in an amount ranging from about 0.1 wt % to about 0.75 wt % based on the total weight of the ink; and
a surfactant including a modified fatty alcohol polyglycol ether in an amount ranging from about 1.2 wt % to about 3.0 wt % based on the total weight of the ink.

12. A printing method, comprising:
thermal inkjet printing, from a thermal inkjet printhead, an ink composition onto a coated textile substrate, the ink composition including:
a dye colorant dispersion present in an amount ranging from about 1.0 wt % to about 7.0 wt % based on a total weight of the ink;
a solvent selected from the group consisting of glycerol, LEG-1, and combinations thereof, the solvent being present in an amount ranging from about 10 wt % to about 22 wt % based on the total weight of the ink;
a chelating agent present in an amount ranging from about 0.05 wt % to about 0.2 wt % based on the total weight of the ink;
oleth-3-phosphate present in an amount ranging from about 0.1 wt % to about 0.3 wt % based on the total weight of the ink; and
a surfactant including a modified fatty alcohol polyglycol ether, the surfactant in an amount ranging from about 0.1 wt % to about 0.4 wt %; and
exposing the ink on the textile substrate to a post-treatment process involving at least heat to form an image on the textile substrate.

13. The method of claim 12, wherein the post-treatment process involves heating the ink on the textile substrate to a temperature ranging from about 182° C. to about 215° C. and exposing the ink layer on the textile substrate to pressure ranging from about 0 psi to about 100 psi.

14. The method of claim 13, wherein the electromagnetic radiation includes infrared radiation or ultraviolet radiation.

15. The method of claim 12, wherein the solvent includes glycerol in an amount ranging from about 10 wt % to about 13 wt %, and the surfactant is present in an amount of about 0.2 wt % based on the total weight of the ink.
